(19) United States
(12) Patent Application Publication
(10) Pub. No.: US 2006/0242313 A1
(43) Pub. Date: Oct. 26, 2006

(54) Network content processor including packet engine

(75) Inventors: Chinh H. Le, San Jose, CA (US); David Tien, San Jose, CA (US); Thanh Truong, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeWiz Communications, San Jose, CA (US)

(21) Appl. No.: 11/449,058

(22) Filed: Jun. 7, 2006

Related U.S. Application Data
(62) Division of application No. 10/141,643, filed on May 6, 2002.

(51) Int. Cl. G06F 15/16

(52) U.S. Cl. 709/230

(57) ABSTRACT

Packets received over a network are routed using a packet engine of the invention based on information contained in layer 4 or above. The information for switching is contained in the header information of the packet. Based on this higher level information, the packet engine may drop the packet, redirect the packet, load balance the packet, perform bandwidth provisioning (e.g., limit the speed of a connection), or adjust quality of service (e.g., change priority or rearrange a queue of packets to be handled), or combinations of these.

### CROSS-REFERENCES TO RELATED APPLICATIONS

This application is a Divisional Application of U.S. application Ser. No. 10/141,643, filed on May 6, 2002. This application claims priority to U.S. provisional application Nos. 60/289,662, 60/289,684, 60/289,677, 60/289,656, 60/289,661, 60/289,664, and 60/289,645, all filed May 8, 2001, which are all incorporated by reference along with any references cited in this application.

### BACKGROUND OF THE INVENTION

The present invention relates to computer and data networking, and more specifically to techniques and hardware to process networking traffic, especially based on content of the transmitted information.

The Web has a number of growing pains: (1) The number of users is extremely large. (2) The amount of data available on the Internet is unfathomable. (3) New applications demand new networking solutions. (4) Bandwidth alone is not the answer. (4) New types of users have new service requirements—commerce, interactive, streaming transactions. (5) The Net is continuously being attacked by hackers and viruses.

Web technology has penetrated the home faster than the telephone, TV, or VCR technologies. No one can dispute that the number of Internet users is very large. The Nielsen/NetRatings reported on September 2000 that there are more than 295 million web users across 20 countries. This penetration is progressing at an astounding rate and continues to grow.

One thing is clear—as more users utilize the Internet, the demand on the backbone infrastructure is stretched to capacity. It is essential that the infrastructure be made faster and faster to serve the masses.

Conservative estimation indicated there are 1.5 billion documents presently on the Internet. This figure will grow to 8 billion in the next several months. No one can doubt that the amount of data on the Web is unfathomable. As more data become available on the Web, its usage will increase exponentially. This in turn will place a severe burden on the Internet infrastructure.

Networking speed is moving toward gigabit and terabit per second range with optical communications technology. This implies an ever-increasing amount of information flowing through the Internet pipeline. More and more demand will be placed on the routers, switches, and servers that process and deliver the information to the users.

However, solving bandwidth alone is not the answer. Internet accesses such as business-critical transaction, wireless Internet communications, voice-over-Internet protocol (VoIP), and Internet distance-learning require more than just bandwidth. These applications are mission-critical, isochronous, and interactive access types. They have low tolerance for delay and require timely response rather than just more bandwidth. The Internet was built with packet switching technology. It provides best effort delivery, does not guarantee timely response, and is subject to unpredictable delays and data loss. As is, it will not meet the requirements of these applications.

Furthermore, these applications make use of new standards such as XML and WML. New processing technology is desired to transfer this information effectively through the Internet.

New types of users are also present on the network. Wireless technology gives user the mobility, and makes the Internet accessible anywhere. This type of users tends to use the Web interactively for browsing, performing a business transaction (such as stock purchase), or e-mailing on the go. Voice technologies are also available for users to access the Internet and performing transactions by voice rather than via the keyboard. They can also conduct audio conversation via the Web. This type of users requires response with predictable delivery at a relatively constant bit rate (streaming rate type).

Hackers and virus problems also impede the Internet infrastructure. Screening of e-mails and attachments requires the network infrastructure systems to search the content of each e-mail message and its attached document or documents for virus strands. This will obviously slow down the infrastructure, delay delivery of information to the users, and create a huge burden on the Internet infrastructure.

As can be seen, there is a need for techniques and hardware to process networking traffic, especially based on the content of the transmitted information. The invention provides advanced technology to solve these problems.

### BRIEF SUMMARY OF THE INVENTION

The invention provides advanced technology to develop leading-edge solutions for content processing to address the problems discussed above. This technology may be incorporated into products for maximizing the performance and reliability of the Internet infrastructure equipment, thus enabling them to perform Internet transactions faster meeting the new application requirements, and making the networks more reliable.

Content processing is a new concept in networking. Previous generations of network equipment use layer 1 to layer 4 of the network protocol to transfer information. These lower layers are the mechanics of how to transfer information across the network. They do not have the information for the network equipment to intelligently prioritize the traffic during transient network congestion to ensure timely response for critical accesses. They do not enable a client to be connected and stay connected to a server for fast response. They do not allow the network equipment to filter specific e-mail type, or application type from impeding a data center. Layers 5 to 7 contain these information and more.

XML and its derivatives such as WML are known as the metalanguage or content language that are used heavily in the e-commerce, wireless Internet applications. They are contained in the in the upper layers of the network protocol. Content processing also involves processing XML and its derivatives to enable effective transactions of XML/WML-based network accesses.

Deep submicron semiconductor technology may be used to implement content processor. This hardware works in conjunction with software to perform traffic management, and traffic shaping functions dynamically. The upper layers of the network protocols are very string intensive. Many upper layer protocols are based on strings rather than binary with defined field structure. A content processor of the invention enables the network infrastructure to parse the string information in the upper network layers on the fly. It also contains deep policy, multifield classification technology to allow the network equipment to perform advanced traffic classification and forwarding. Network equipment containing a content processor of the invention can perform advanced traffic management and traffic shaping at the highest rate. Moreover, this technology has the least network access latency comparing to any other possible solutions. It's designed to suit the processing requirements of high speed networking equipment and its sub-systems that are typically found in the Internet infrastructure's backbone and data centers. In summary, the content processing technology has three major components:

The processing technology—processes network data packets on the fly. It consists of TCP/IP layers and layers 5 to 7 parsing. It disassembles the packets for layer processing, and reassembles them for forwarding. It dynamically parses the string protocol and data in the network data stream. It supports various protocols for Web, e-mail, XML/WML-based applications. The classification technology—its main function is to classify traffic for QoS, filtering, switching/redirecting, and load balancing applications. It contains a rules engine that processes the network policies. The network policy database allows the network manager to configure, manage, and redirect the network traffic. The switching system software—Uses the hardware to perform network applications and system management. It provides the network manager a graphical user interface for configuring the system. It gathers and displays network statistics. It has the capability to handle abnormal network cases such as server failure to make the network resilience. Dynamically, it allows the network manager to program networking rules into the system for tuning the network. Note each hardware unit contains its own internal memory core for fast processing. The processor also has external memory expansion for large scale, multi-connection, multi-thread packet store and management.

This technology has applications in both the Internet core and edge. It can be used in core routers and edge switches, traffic management systems. It gives this equipment a new level of intelligence to perform networking applications.

Products incorporating the invention include layer 3-7 content processing technology which performs traffic management functions that include traffic prioritization, bandwidth allocation, load balancing and traffic filtering of infected data packets. These products may fit in with existing network equipment, typically sitting between the network's router/switches and the server cluster. Both XML and normal Web traffic are supported. The invention may be implemented using one or more integrated circuits that process layer 3-7 information in the network packets and redirect or filter network packets to allow the system to perform intelligent network functions. These integrated circuits support advanced XML and normal Web traffic. The processor performs functions in hardware, enabling the network equipment to perform advanced network functions with the least latency and highest performance.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows an example of an application without a network processor.

FIG. 2 shows an example of the content processor in a traffic management appliance.

FIG. 3 shows a block diagram of a content processor including a packet pre-processing, protocol parser, policy-based classifier, packet modification and forwarding engine, and system interface functions.

FIG. 4 shows a more detailed diagram of a specific implementation of a content processor.

FIG. 5 shows an OSI layer map of layers 1 through 7. The content processor of the invention is capable of processing layers 5 through 7.

FIG. 6 shows a block diagram of the packet engine.

FIG. 7 shows the packet engine's host bus interface unit.

FIG. 8 shows a diagram of packet engine's IP extractor.

FIG. 9 shows a diagram of packet engine's TCP extractor.

FIG. 10 shows a block diagram of a packet engine design.

FIG. 11 shows a diagram of sequence and acknowledge number mapping.

FIG. 12 shows a more detailed diagram of the packet extractor.

FIG. 13 shows a top view of the packet building process.

FIG. 14 shows a FIFO of pointers to addresses in the RAM tat is expected from the packet engine.

FIGS. 15 and 16 show a flow diagram of content processor packet connection flow.

### DETAILED DESCRIPTION

The present invention may be used in many types of networking products including, for example, in the intelligent network equipment market. Generally, this class of network equipment is known as layer 5 to 7 or intelligent content switches. This new breed of intelligent switches enables network managers to implement functions such as traffic prioritization, bandwidth allocation, access control, and load balancing. Network managers leverage this type of equipment to exert more control over the network to bring enjoyable Internet experience to their customers. Layer 5 to 7 Web switches also perform the functions typically found in lower layer switches which are layer 3 (IP switching) and layer 4 (TCP switching). In summary, layer 5 to 7 Web switches are switches that front-end Web server farms and dynamically direct specific content requests to the best site and best server at that moment to serve the transaction. The system utilizes layers 5 to 7 information to make decisions about which server the network packets should be sent to. With their deeper content awareness, these switches provide greater performance and reliability to e-commerce sites, Web hosting companies, content providers, and even traditional enterprises.

The market for intelligent network equipment is accelerating. It's growing at a compounded annual growth rate of 81.5 percent, and forecasted to reach $4 billion by the year 2004. Within this market segment, the technology and products of the invention may be used to address the applications that are business critical and sensitive to network latency.

The following discusses how the content processor can be used in the Internet routers, switches, and network traffic management equipment. These systems can take advantage of the technology's upper layers processing of network packets. The actual specific design implementation is system architecture dependent.

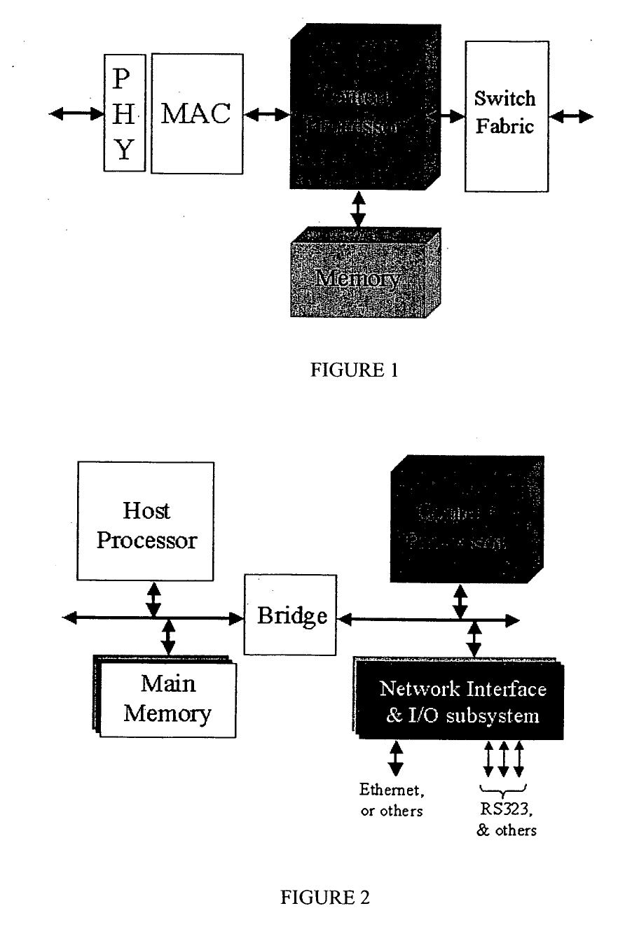

For High Speed Core Routers: In high-speed core routers, the content processor can reside at the port level or in the routing engine depending on the router's architecture. At the port level, the content processor can be used with or without a network processor after the PHY and MAC processing. FIG. 1 shows an example of using it without the network processor. If a TCP/IP based network processor exists in the system, the content processor would mainly perform the layer 5-7 processing and classification for the network processor.

Another use is in the routing engine, the content processor can work in conjunction with the routing engine to perform preprocessing of the incoming data from the network interface channels. The content processor can perform all the traffic management functions, QoS assignment, filtering, etc. prior to sending the packets to the routing logic for sending them on to the Internet. Multiple content/routing engines can be implemented in a system to enable parallel processing and form deeper network policies.

For the Edge Switches: The content processor can be used in conjunction with a host processor or an embedded processor to obtain gigabit switching at line rate with minimal increase to system cost. The content processor handles all the data-intensive network packet processing, traffic management functions using layer 3-7 information. The host processor performs all the system management, application specific functions. The content processor also contains special instructions to assist the host processor accelerate the processing of network related tasks.

For the Traffic Management Appliances: Traffic management appliances are network equipment that control the flow of network information and applications. Examples of these are firewall devices, load balancers, traffic shapers, application bandwidth allocators, server or SAN management functions.

The content processor architecture is designed to easily fit into network traffic management appliances. It can work in conjunction with a host processor such as x86, PowerPC™, MIPS™, or others to perform traffic management functions. The content processor's layer 3-7 processing hardware allows it to perform traffic management functions at the highest rates. Its flexible architecture allows it to support various protocols making it suitable for a wide range of applications. FIG. 2 illustrates an example of the content processor in a traffic management appliance.

An example of a intelligent network equipment product incorporating the invention is the Traffic-Smart 240/440™ Web switch by LeWiz Communications. These technologies include Web switches that use a layer 3-7 content processing ASIC. These solutions are designed for high performance and high availability e-commerce, hosting and enterprise environments.

The Traffic-Smart 240/440's unique layer 3-7 XML content processing technology performs traffic management functions that include traffic prioritization, bandwidth allocation, load balancing, traffic filtering of infected data packets that in turn result in a more efficient use of bandwidth, maximizing server cluster efficiency and enabling a more reliable network. The Traffic-Smart 240/440 Web switches fit in with existing network equipment, typically sitting between the network's router/switches and the server cluster.

The traffic-smart switch products offer unique capabilities, performing network switching functions with the least latency and nonblocking. Designed for OEMs, the products are extremely suitable for mission-critical, latency sensitive applications such as those typically found in trading, finance, manufacturing and freight businesses. One goal is to deliver powerful products that are cost effective and high performance giving our customers the best return on their investment.

The technology solves the Internet slowdown, loss of data and filters harmful attacks from hackers and viruses through its content processing technology. The product family alleviates the burden of servers from performing networking functions and allowing them to dedicate their processing power to performing applications, which is their main purpose in any data center. The products also organize and redirect traffic to the server and SAN farms while detecting and discarding infected packets to a network manager.

The Traffic-Smart 240/440™ Web switch is designed to make the Internet faster, more efficient and reliable for e-commerce and Web hosting environments. The Traffic-Smart 240/440s unique layer 4-7 XML content processing technology performs traffic management functions that include traffic prioritization, bandwidth allocation, load balancing and traffic filtering of infected data packets that in turn result in a more efficient use of bandwidth, maximizing server cluster efficiency.

The Traffic-Smart 240/440 monitors incoming traffic and dynamically uses pre-programmed networking rules to perform traffic prioritization, load balancing and traffic filtering.

The Traffic-Smart 240/440 performs quality of service (QoS) based on business parameters making each data packet transferred across the company's network contribute to the company's profit, thus maximizing each transaction beyond what can be done at the TCP/IP level. This feature allows Web sites to offer better customer service by ensuring faster access for valued customers. The network manager can select different levels of QoS based on programmable options such as user's ID, specific application performing by the user, XML fields and others.

The Traffic-Smart 240/440 performs load balancing beyond using the URL or cookie method. It also performs load balancing using server-weighted percentage, predicted response time, maximum server connections and other options.

Traffic that comes through the Traffic-Smart 240/440 can be rejected or redirected based on options such as XML fields, SMTP/email fields, HTTP fields or even the IP address. This makes the company's network more reliable and secure.

To Enhance performance, the Traffic-Smart 240/440 merges small network packets from the clients to optimize throughput between the server and the switch. This feature also reduces the workload off the servers.

The Layer 4-7 Traffic-Smart 240/440 provides graphical views of detailed traffic information. This allows the network manager to track network traffic and to tune the network dynamically in order to relieve bottlenecks or to perform traffic shaping for best user response time.

The Traffic-Smart 240/440 switch fits in with existing network equipment, typically sitting between the network's router/switches and the server cluster.

Products such as the Traffic-Smart 240/440 switch are electronics systems implemented using integrated circuits and software. The invention may be embodied using integrated circuits such as ASICs, microprocessors, memories, programmable logic, field programmable gate arrays, and many others. An example of an ASIC integrated circuit is the Content Processor 5000™. This processor is designed for ease of use in intelligent network equipment. Generally, these systems are known as layer 4-7 smart switches or network equipment that enable network managers to implement functions such as traffic prioritization, traffic shaping, band-width allocation, access control and load balancing. The Content Processor processes layer 3-7 information in the network packets and redirects or filters the packets to allow the system to perform intelligent network functions. The processor executes these functions in hardware allowing the network equipment to perform network functions with the least latency and highest performance.

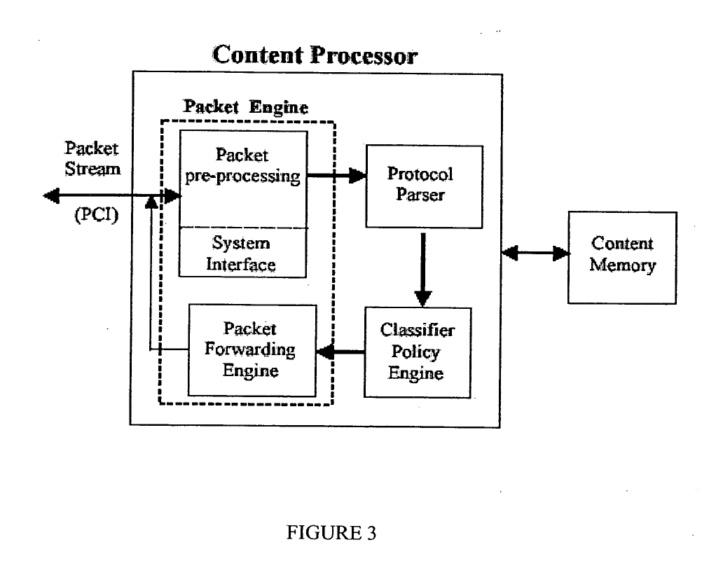

The content processor is implemented in deep submicron semiconductor technology. It consists of five major units: packet pre-processing, protocol parser, policy-based classifier, packet modification and forwarding engine, and system interface functions, as shown in FIG. 3. Note three of these units are logically grouped together as the packet processor and will be described together as one block in FIG. 3.

Features of the integrated circuit include: High performance, low latency; Gigabit capability at line rate, nonblocking (OC-48 and higher); Process deep into layer 5-7 of packet—more intelligent switching, traffic management; Providing XML capability for the upper layer processing, XML protocol handling; URL switching; Switching action based on upper layer parameters such as date, from, to, subject, content-type, etc. Fast forwarding of packet; Perform table look up of connections; Programmable protocol, policy, keyword extract; Scalable in rules and data flows; Support for persistent connection based on cookie, URL, source IP; Support QoS, traffic prioritization; Support load balancing based on rules; Packet filtering, discard, re-direct based on rule or rule parameters; Check and generate check sum, CRC; Ease of interface to PCI with master and DMA capability; Controlling fast external memory for storing packet data and traffic control information; Support for server error interception and redirect.

The invention may be implemented in the form of ASIC integrated circuit or as a PCI plug-in card and may be also provided for SoC integration (such as being distributed using Verilog based code). Full software support with configuration and traffic management functions is provided. Complete traffic management system reference design using the content processor is also available.

The packet processor: Three blocks of the content processor are grouped together and described below as the packet processor. These blocks include the system interface, the packet pre-processor, and the packet modification and forwarding engine.

The packet processor receives the packets from the external system bus and processes the layer 3-4 (TCP/IP) of the network data packets on the fly. It disassembles the packets and sends the upper layer information to the protocol parser for upper layer protocol processing. The processor handles TCP/IP session termination and does session table walks for tracking of TCP/IP connections.

The Content Processor 5000 interfaces to the external bus and controls the content processor's memory. The processor also controls the internal blocks of the content processor for the host to configure it.

After the upper layer information is processed and classified, the results are fed into the packet processor for editing the packet and forwarding the packet on to its determined destination with the right QoS. If the packet is to be discarded the packet processor removes it from the queue.

Some features of the packet processing block include: Layer 3-4 packet processing; Performs TCP/IP disassembly; TCP/IP session handling; Queuing of packets on the in-bound and the out-bound; Forwards layer 5-7 information to protocol parser; Edits the layer 3-4 information for fast forwarding of the packet; Reassembles the packet with the right QoS, destination; Generates new check sum, CRC; Discards the unwanted packets; Capable of supporting millions of concurrent sessions; Tracks traffic flow to perform session persistence and fast forwarding; Terminates client accesses and handles server connections; Interface to the internal blocks for configuration and error handling; Interface to external content processor memory (fast pipeline ZBT SSRAMs); Interface to the system bus (64 bit, 66 MHz PCI) and communicate with the host processor.

The protocol parser: The protocol parser receives the layer 5-7 data from the packet processor. It feeds the data through selected upper layer protocol processing blocks and identifies keywords required for forming the query to search in the policy database of the classifier. The parser can support various protocols including string based protocols such as HTTP, ebXML or binary based upper layer protocols.

Some features of the protocol parser block include: Process upper layer protocols; Supports: HTTP, SMTP, ebXML, NFS, CIFS, and others; Contains keyword look-up engine with programmable dictionary; Fast extraction of string tags; Fast search of string data; Compose search query based on keywords and layer 3-4 information for the classification.

The classifier: The classifier is a large policy, rules engine. It contains the policy database for classifying network traffic per flow. Query rule parameters from the parser are fed into the classifier for searching in the database. The result is used to redirect traffic with predetermined QoS assignment or discard the packet.

Some features of the classifier block include: Deep policy database (16K policies); Classify traffic packets based on layer 3-7 information in hardware based on, among others, TCP information such as source port, destination port, IP information such as source IP address, destination IP address, XML fields such as person name, action to be taken, URL, cookie information; Produce results for Packet redirect, Packet discard, or filter, Packet prioritization, QoS assignment; and Fast search in hardware.

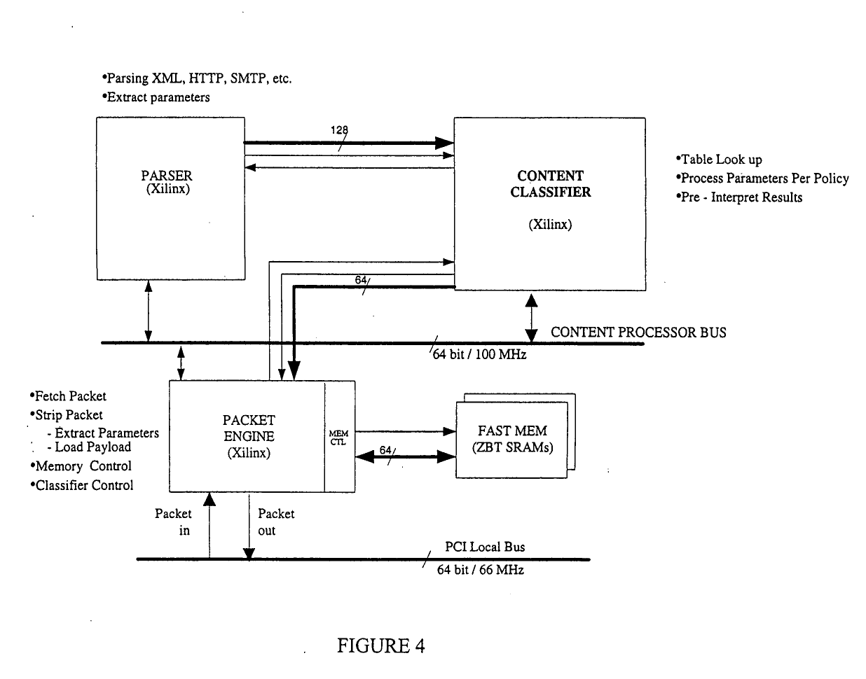

FIG. 4 shows a more detailed diagram of a specific implementation of a content processor. There are many other possible implementations. This content processor is implemented using field programmable gate arrays. In a specific case, the field programmable gate arrays are manufactured by Xilinx. However, in other implementations, other programmable logic may be used, such as integrated circuits manufactured by Altera, Lattice, Atmel, or Actel. Furthermore, gate arrays may also be used, such as those produced by Toshiba and LSI Logic. The content processor includes a parser, content classifier, and packet engine, all connected to a content processor bus. This bus is 64 bits and clocks at 100 megahertz. The packet engine receives and outputs packets onto a bus, such as a PCI local bus. The packet engine fetches packets and also strips the packets to extract parameters and the load payload. The packet engine includes memory and classifier control. Additional memory may be provided to the packet engine by interfacing the chip with SRAM memory.

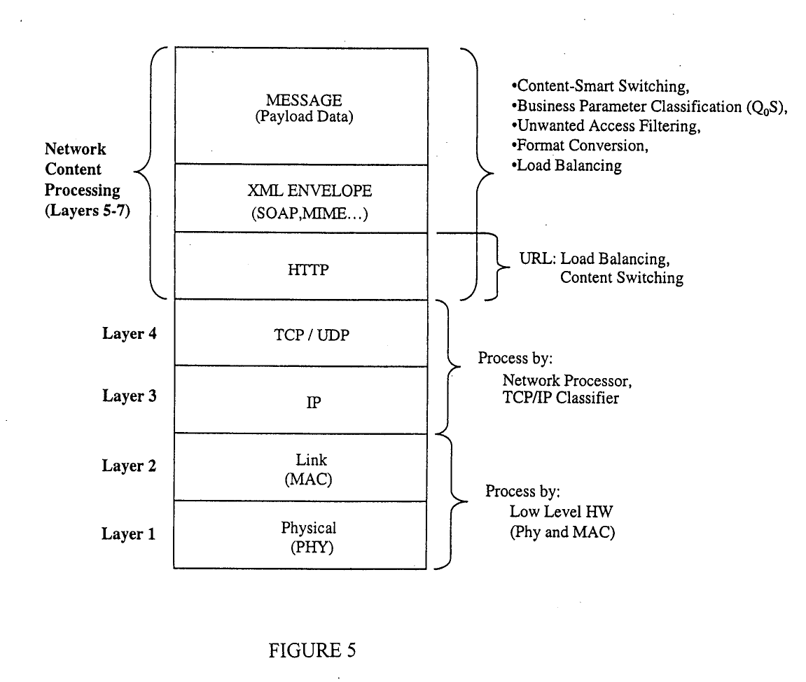

FIG. 5 shows an OSI layer map of layers 1 through 7. The content processor of the invention is capable of processing layers 5 through 7.

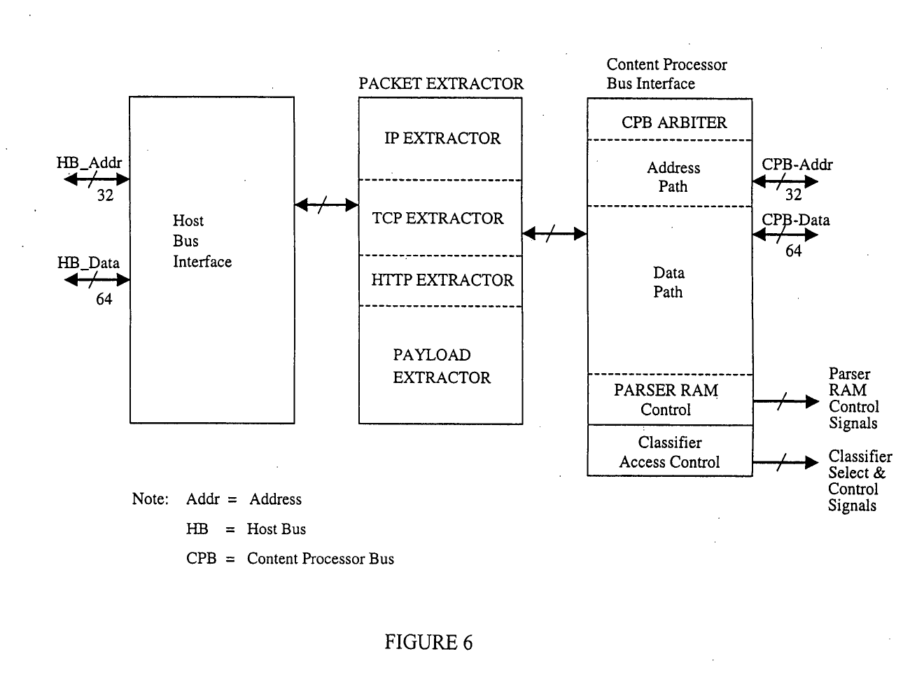

FIG. 6 shows a block diagram of the packet engine. The packet engine retrieves the network packet from the line card and pre-processes the packet header for the parser. The result is fed into the parser for HTTP and XML parsing. The packet engine's main function is to interface with the system to retrieve the full 7-layer data packet, and pre-processes it for the parser. It also contains the interface to the content processor's local bus.

In the first XML Traffic Server, the line card's MAC chip has the ability to move the network packet from its temporary buffer (FIFO) to main memory automatically. Upon receiving a packet from the network, the packet is stored in the MAC's local FIFO. The MAC's DMA engine then moves the packet to the system's main memory (host memory). The host and associated software detects this event. One possible way to detect an event is through interrupt and the interrupt handler. The host then gives a command to the content processor (CP) to perform the desired function on the packet. Since the CP is performing the function in hardware it is expected to be many times the performance of the host for the same function. In a specific implementation, the desired performance increase is at least 10 times.

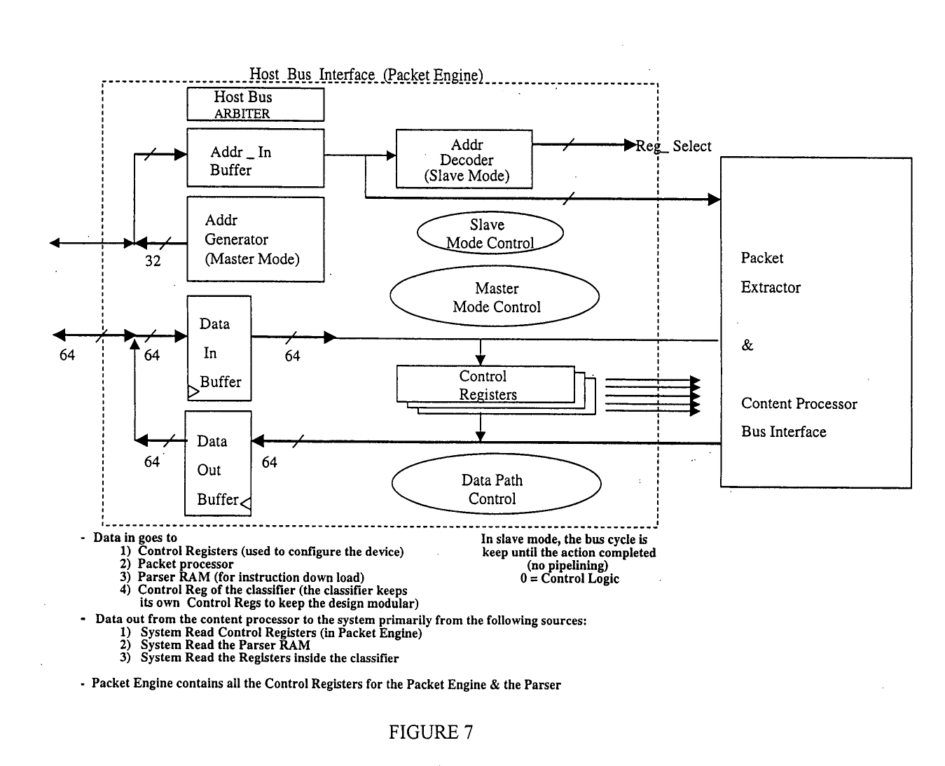

FIG. 7 shows the packet engine's host bus interface. This is the unit that interfaces to the host. It should have a master bus interface unit to access the host's main memory. The main purpose here is to read the packet's data in main memory. This bus interface also should be able to decode the host's command and acts on it or passes it to appropriate unit or units within the content processor to perform the function. The bus interface also should allow the host processor to access the following areas: (1) the packet engine's registers, (2) the parser's local RAM, and (3) the classifier's registers.

In this case the packet engine's host interface is in slave mode.

The packet engine has a packet extraction unit. In master mode, the packet engine's host bus interface should arbitrate for the bus to fetch the packet's data in 64-bit chunk at a time. After the data is fetched, it's passed on to the packet extraction unit for processing. The packet extractor's main purpose is to extract: (1) the TCP/IP parameters required by the classifier; and (2) the XML data payload for the parser. This consists of the HTTP header and the XML message. The results of the extraction form a data structure and stored into the parser's local RAM.

The TCP/IP parameters for extraction are: (1) IP source address (in IPv4, this is 32 bits); (2) IP destination address (in IPv4, this is 32 bits); (3) TCP source port (16 bits); and (4) TCP destination port (16 bits).

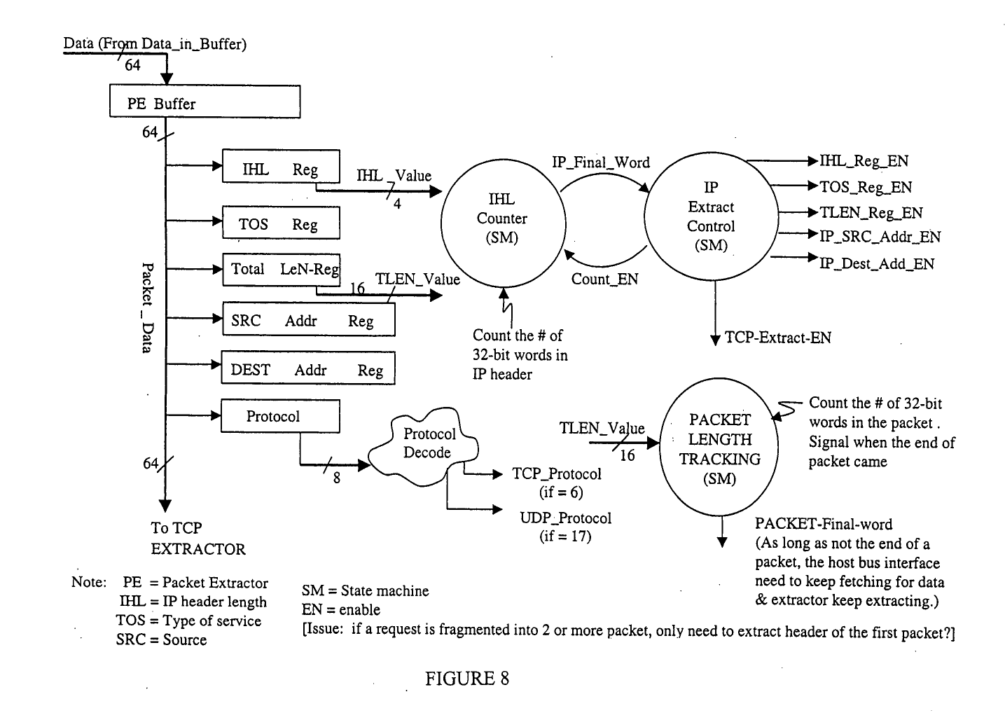

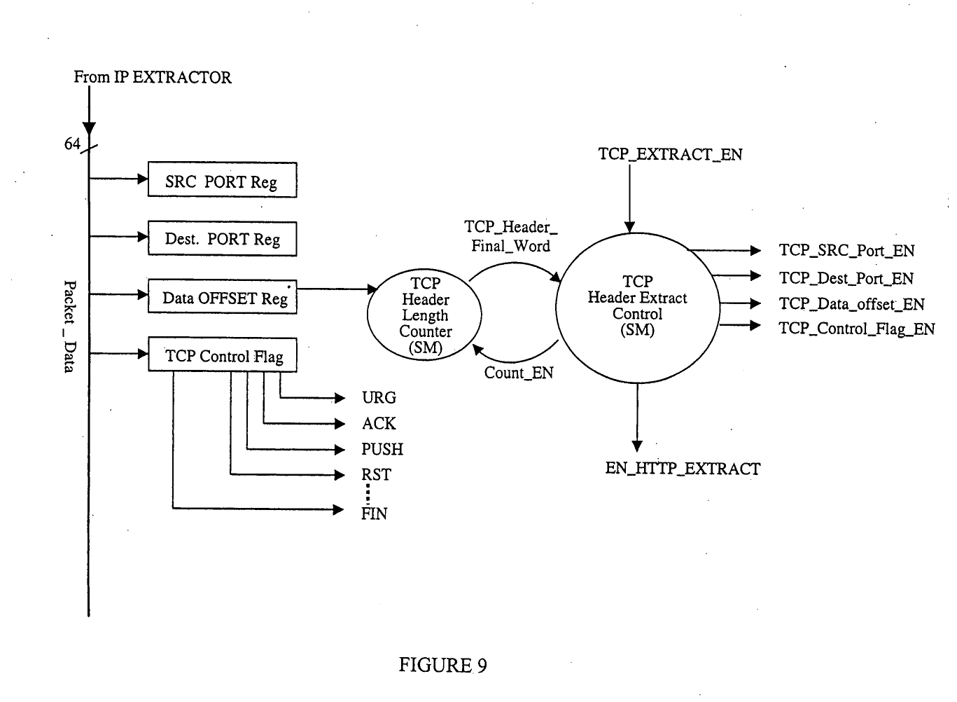

The following describe some of the key issues in extracting the TCP/IP header. FIG. 8 shows a diagram of packet engine's IP extractor. FIG. 9 shows a diagram of packet engine's TCP extractor. FIGS. 8 and 9 illustrate the concept of the IP and TCP extraction units inside the packet extractor.

TCP has the DataOffset field (4-bit) to indicate the number of 32-bit words in the TCP header. This is used in stripping the TCP header. In hardware implementation, this field can be used to count the number of 32-bit words retrieved by the content processor. The content processor keeps the required fields in a descriptor locally. It also keeps the payload and throw out the rest of the information. The DataOffset field is in the 4th 32-bit word. This means some of the header information can came in already before the content processor hardware can match the DataOffset count. Also the content processor fetch 64-bit chunk at a time not 32-bit. The counting of the header words should take this into account. This can be done in a simple state machine rather than a straight counter.

IP has 4-bit InternetHeaderLength (IHL) field to specify the number of 32-bit words in the IP header. Maximum IP header is 60 octets, typical is 20 octets. The IHL is used in stripping the IP header. The counting of the number of words here is similar to the TCP DataOffset counting.

IP also has the TotalLength field (16 bits) to indicate the total length of the packet (IP header and payload) in octet. The content processor hardware uses this to track the end of the packet's payload. The packet engine strips the IP header, and the TCP header. Sends the rest of the information or the payload to the parser. However, this should be less than the TotalLength−the IPHeaderLength in byte−TCPHeaderLength in byte.

The packet engine's content processor bus interface unit: The content processor's internal bus operates independently of the host's system bus. Both of these buses operate at the same clock frequency or a multiple there of. For the host processor, the packet extractor, or the parser to access the content processor's local RAM and the classifier's registers, the accesses should go through the packet engine's CP bus interface unit. This CP bus interface unit acts as the central control for all resources inside the content processor.

It has a central arbiter. This arbiter by default gives the CP bus to the parser when not in use. It gives the CP bus to the packet engine on a needed basis. When both the parser and the packet engine request the bus, the priority is given to the packet engine since host accesses to the internal register should be timely. The bus is default to the parser for performance reason. During long processing, the parser should not be required to arbitrate on a cycle-to-cycle basis.

The CP bus interface contains the control for the parser RAM. When the CP bus master (can be either the parser or the packet engine) generates an address, this control logic decodes the address. If the address matches the range of the parser RAM, the control logic allows the data to be written to or read from the parser RAM. A state machine is needed to control this access timing.

The CP bus interface also contains the control logic for accessing the classifier's resources, i.e. registers, and RAMs. This control logic decodes the addresses and generating the required control signals for all accesses to the classifier's internal resources. To simplify the design, it may share the state machine and decoding logic for the parser RAM control.

The latency of the accesses to the parser RAM and the classifier should be minimized to enhance performance.

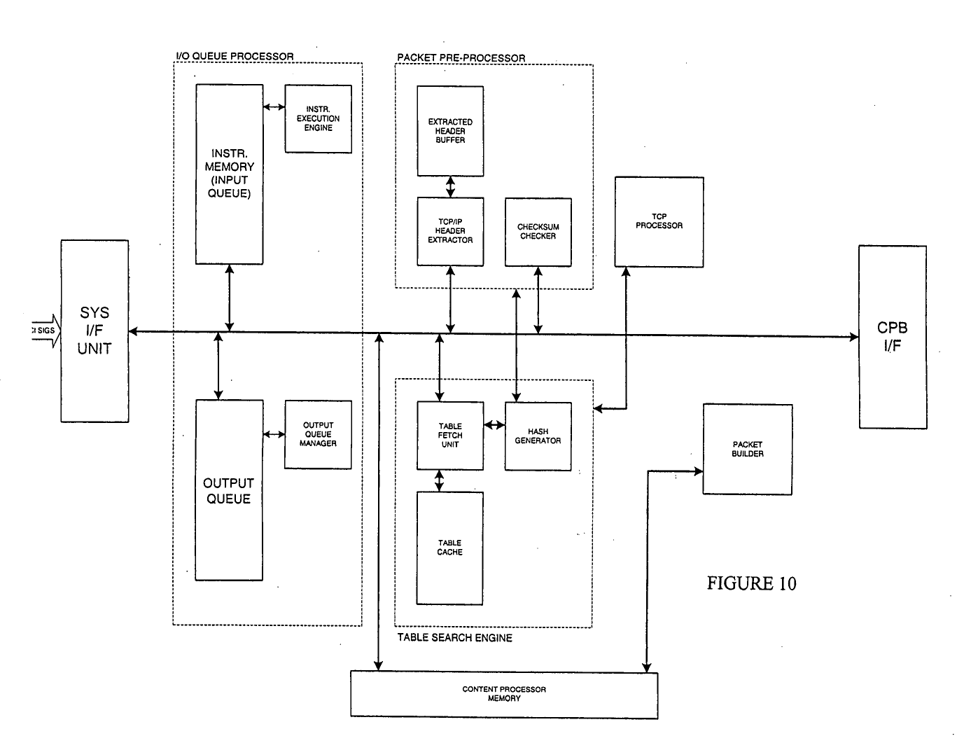

FIG. 10 shows a block diagram of a packet engine design. The Packet Engine is the interface to the system for the Content Processor. It accepts the data from the system and extracts TCP/IP information on layer 3 and layer 4 of the network packet and transfers the message of the network packet to the Parser and Classifier for layer 5-7 processing.

The Packet Engine is responsible for maintaining the input and output queues; as well as, arbitrating the internal Content Processor bus and the internal memory bus. Essentially, the Packet Engine serves as the traffic cop between the system and the internal units of the Content Processor, such as the Parser, Classifier, and Internal RAM.

The MAC chip will be preprogrammed to unload its FIFO directly into the Content Processor memory instead of main memory. The Packet Engine will pre-process the network data as it is transmitted into internal memory.

The Packet Engine must only transfer complete TCP segments to the Parser for upper layer processing. Therefore, IP fragmentation and TCP segmentation must be handled by the Packet Engine.

After the protocol parsing and rules classification is completed, the result will be passed back to the Packet Engine. The Packet Engine will be responsible for detecting the completion of upper layer processing, and signal the Packet Builder to rebuild the packet with new TCP/IP header information. The newly rebuilt packet will then be placed on the output queue for transmission back onto the network.

The Packet Engine will also be responsible in forwarding packets. Forwarding occurs after a connection has been classified and re-routed. This situation will be the normal flow of packets and thus should be optimized as such. All incoming packets from the client are forwarded to the server, and server packets are forwarded to the client. Certain changes and checksum calculation will still be made to the TCP/IP headers.

Moreover, each connection can have multiple requests to the server. Thus, for complete load balancing, each new request in a connection should be classified and re-routed. This requires an additional processing step during forwarding. Byte count must be kept of the connection to detect the end of the current request.

The Content Processor will run internally asynchronous to the system bus speed.

In a specific design, the external bus clock will operate at 66 Mhz, and the Content Processor will run at 100 Mhz. The Packet Engine will be responsible for synchronizing the incoming and outgoing data relative to these frequencies.

The combination of the Instruction Queue and the Output Queue provides a complete hardware/software interface for all Content Processor functions.

FIG. 10 shows an input instruction queue. In an implementation, the instruction memory structure of input instruction queue has 32 K bytes, with each instruction being 16 bytes wide. Therefore, 2000 instruction entries are possible.

The Instruction Memory will be divided into blocks of 4, with each block containing 500 instructions. The purpose is so that corruption doesn't occur between the hardware and software attempting to access the same instructions.

Each block will have a bit indicating whether software or hardware has access. Software will set this bit when it enters new instructions, hardware will only process the block if the bit is set. After hardware has processed the instructions in a block, it will reset the bit, allowing software to enter and process the status or enter new instructions.

There will be a single 32-bit Instruction Queue Control Register that will contain all these bits.

FIG. 10 shows an instruction execution engine. The Host Processor will load the instruction memory of the Content Processor. Each instruction will be 128 bits wide. They will contain a command, status, data pointer and data length field. The processor will load this memory before the MAC begins transfer into the CP. This allows the Packet Engine to perform on-the-fly processing.

The Execution Engine contains several pointers to keep track of the execution status of each entry. The red pointers are the Pre Process pointer, Hash Process Pointer, Fetch Process Pointer, TCP Process Pointer, Build Process Pointer, Parse Process Pointer, and the Clsfr Process Pointer.

The Pre Process Pointer tracks the extraction of TCP/IP headers and performance of checksum. The Hash Process Pointer tracks the generation of hash. The Fetch Process Pointer tracks the fetch connection table. The TCP Process Pointer tracks performance of TCP session handling and creation of new packets. The Build Process Pointer tracks building packets. The Parse Process Pointer tracks parser execution. The Clsfr Process Pointer tracks classifier execution.

The pointers will initialize at the first instruction entry. As each process is completed, the pointer is advanced to the next entry. Based on the internal status field of each entry, the Execution Engine will be able to determine if the process can be executed on the current entry or if it requires to wait until another process has been completed. For example, a TCP process cannot be performed on a network packet until hashing and table fetching have occurred.

The Instruction Execution Engine should process status that it receives from the other processing blocks. So for example, if it receives a extractor finish signal for a particular entry, then it must recognize that the extracted headers has already been stored away in the buffer, and that the packet will continue processing at the next stage which would be the checksum calculation.

This architecture will allow several different processes to occur in a pipelined fashion.

Thus, as network packets enter into the Content Processor, header extraction and checksum can be performed on the fly. TCP state information needs to be known before TCP session handling can occur which requires fetching the connection table. Therefore, as the connection table for one entry is being fetched, on-the-fly header extraction and checksum calculation can occur for newly arriving packets without any bus interruptions.

FIG. 10 shows an output queue unit. The output queue serves two main purposes: (1) allow long term storage of state information, partial segments, fragments, cookies, and other similar data, and (2) passing data to software which the hardware can not process.

The Output Queue Structure will be set up much like the input instruction queue. The output queue size will only be 16K, allowing for 1000 entries in a specific implementation. It will be split up into 4 separate blocks to allow software and hardware to operate independently without corruption issues.

The processor will load the output queue with entries pointing to free buffers inside CP memory. The entry will also contain a pointer to a location of the same size in system memory. This allows hardware and software to stay in sync if data is moved out into system memory for long-term storage.

Each entry will point to a location in CP memory that may be used for storage. The maximum buffer size will be 8K. There may also be 2K blocks. Each buffer should be large enough to contain all data to be stored. There will not be buffers which contain pointers to more buffers.

The CP will store away information in free buffers pointed to by the output queue. Each entry will also contain a pointer to a location in system memory. These spaces will be pre-allocated by software. When software comes to process the output queue, it will transfer data sitting in CP memory into System memory for long-term storage.

At this point, it is up to the internal CP units to remember the Destination in System memory that the data has been stored. This can be done through the connection/state tables.

It will contain a control bit for each block to specify hardware or software access, similar to the Instruction Queue setup. Also, it will contain a bit that will allow software to indicate to the hardware to jump to the next block. This allows software to immediately process a block when it needs it. There will be a 2 bit field indicating which block hardware is currently working on.

There will be a single 32-bit Output Queue Control Register that will contain all these bits.

FIG. 10 shows an output queue manager block. The Output Queue Manager is responsible for providing internal units, such as Parser or Packet Builder, with free buffers to store information. It will maintain a pointer for each block which requires a buffer space. After the data has been stored into the buffer, the individual units must be responsible for informing the Queue Manager with the byte count, data that was stored, and required location.

The Queue Manager will update each queue entry as it receives information from the individual units. The updating of the queue entry allows hardware to notify software what to do with the current data: process, store, or discard.

In the case of the Parser, it may be simpler for the Parser to simply update internal Parser registers with the result. Upon detection of Parser complete, the Packet Engine will read from those registers and update the output queue entry.

A unit may only use a single entry at any given time, therefore, it must signal completion of a current queue entry to the Queue Manager before it will receive another free buffer.

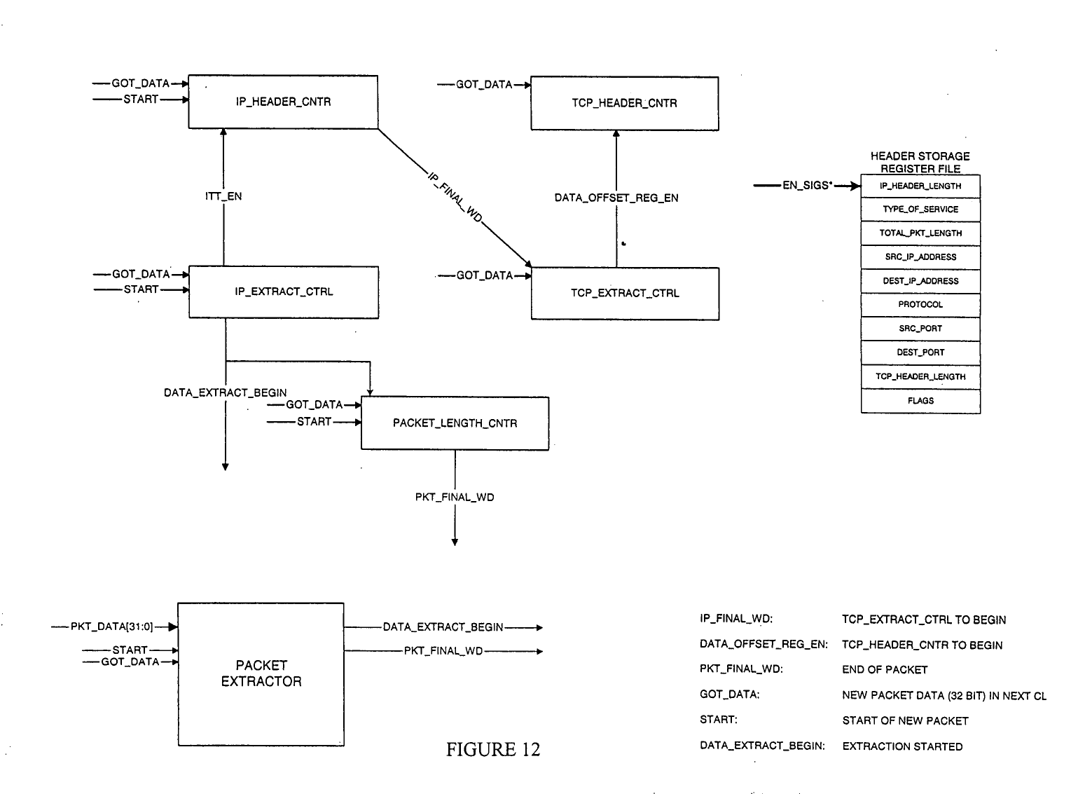

FIG. 10 shows a TCP/IP Extractor block. FIG. 12 shows further details of the packet extractor. This block will extract the TCP/IP header information on the fly. The data will be stored into the Extracted Header Buffer for future use. The Extractor accepts a start command which indicates that it is a new packet, or a continue command which indicates that it is the previous packet. In any case, the extractor must keep it's own previous state, if it receives a start command, it will simply reset all states.

There will be no long-term storage of state information for this block. Therefore, if a packet is partially processed for headers before a new packet enters, the partial information is simply lost, and must be completely reprocessed. This actually should not occur unless an error occurs on the MAC, and therefore a dropping or ignoring of the packet is justified.

When a packet has been completely stripped of its header information, the Extractor will signal the Instruction Execution Engine to indicate the fact. The Instruction Execution Engine, will update it's own status corresponding to each instruction entry to indicate that the current entry has already been extracted for header information.

The extracted header information is not stored into CP memory as was described in the original design. Instead, the relevant information will be stored into the connection table. This is so efficient handling of information between hardware and software can be synchronized and easily maintained.

In one specific implementation, IP fragmentation will not be handled. If an IP fragment is detected, the Instruction Execution Engine will be informed to allow updating of the status in the entry. Other implementations may include fragmentation reassembly.

Also, at the IP layer, no IP options need to be worried about. These options are usually previous route information and timestamp issues that the Content Processor is not concerned with.

FIG. 10 shows a checksum checker block. The Checksum Checker's purpose is to calculate the IP header checksum and TCP checksum on the fly. The Extractor will simply indicate to the Checksum block when new data is available, the IP header checksum will immediately begin calculating the Checksum.

The TCP checksum will begin after receiving a TCP checksum start from the Extractor. The Extractor must save the Pseudo header for TCP calculation, when this has been stored into a temporary register, then the start signal will be sent to the TCP checksum calculator.

In either IP or TCP checksum calculation if a checksum error is detected, the Instruction Execution Unit will be signaled. The entry is flagged as having an error in the status field and will be ignored for any further processing.

FIG. 10 shows a TCP Processor block. The TCP Processor will only accept completed segments, therefore, it will not be able to process data on the fly. The reason is that for TCP operations to function correctly, TCP state information is needed, which requires a lengthy hash generation, table fetch and look up. Also, TCP session handling can not occur until a complete segment has arrived and verified to be error free, otherwise, one risks the possibility of creating an erroneous SYN-ACK packet.

Therefore, the TCP Processor will receive an indication from the Instruction Execution Unit that a segment's table information has been fetched and TCP processing can occur.

It does not require any reading of packet data from memory, all relevant information that is required by this block will be found in the connection table. At this point, the block will perform such functions as session handling and options processing. Session handling requires creation of new packets which means that the Packet Builder will need to be signaled to build new SYN, ACK, FIN, and other packets.

Also, the decision to forward a segment on to Parser is performed within this block. In parallel with handshaking and session functions, the TCP segment will be forwarded to the Parser along with the parser table descriptor and handle information for Protocol Parsing.

This block need not wait for Layer 5 data before deciding to forward onto the Parser. If an unconnected packet contains only TCP/IP information, then this will also be forwarded to the Parser for descriptor building and Classifier processing. The reason for this is because certain packets may be Classified with only TCP/IP information.

Segmentation handling needs to be performed on new connections that require Parsing and Classification. Once a connection has been Classified, packets will simply be forwarded and segmentation can be ignored. Segment tracking will be performed through the connection table. If a segment arrives out-of-order it will be placed in the output queue, and its location will be stored in the connection table for future processing.

This block should also retransmit any segment which does not get ACKed. This involves using the timers in the TCP layer to periodically re-transmit a segment if an ACK has not been received yet.

The TCP Process Block also must handle TCP options, such as the maximum segment size (MSS) and window scale factor. Both of these options are negotiated during connection establishment. Since the Content Processor will handle the initial handshake it must be able to perform these two option negotiations. However, it will not know the server capability at this point. One possible solution is to ignore all TCP functions and only perform the default.

A more flexible and efficient approach is that the Content Processor will contain a single 32-bit programmable register which allows software to program the minimum variables supported by the servers. For example, before system initialization, the host CPU should probe the servers to find out the minimum values supported (or the network administrator will know) and enter them into the registers. If no values are given then the default values will be used. These values will then be used for the option values during connection establishment.

In one embodiment, the TCP Options Control Register has 32 bits where bits 31 to 24 are reserved, bits 23 to 16 are for a window scale factor, and bits 15 to 8 and bits 7 to 0 are for Window Scale Factor Maximum Segment Size (MSS).

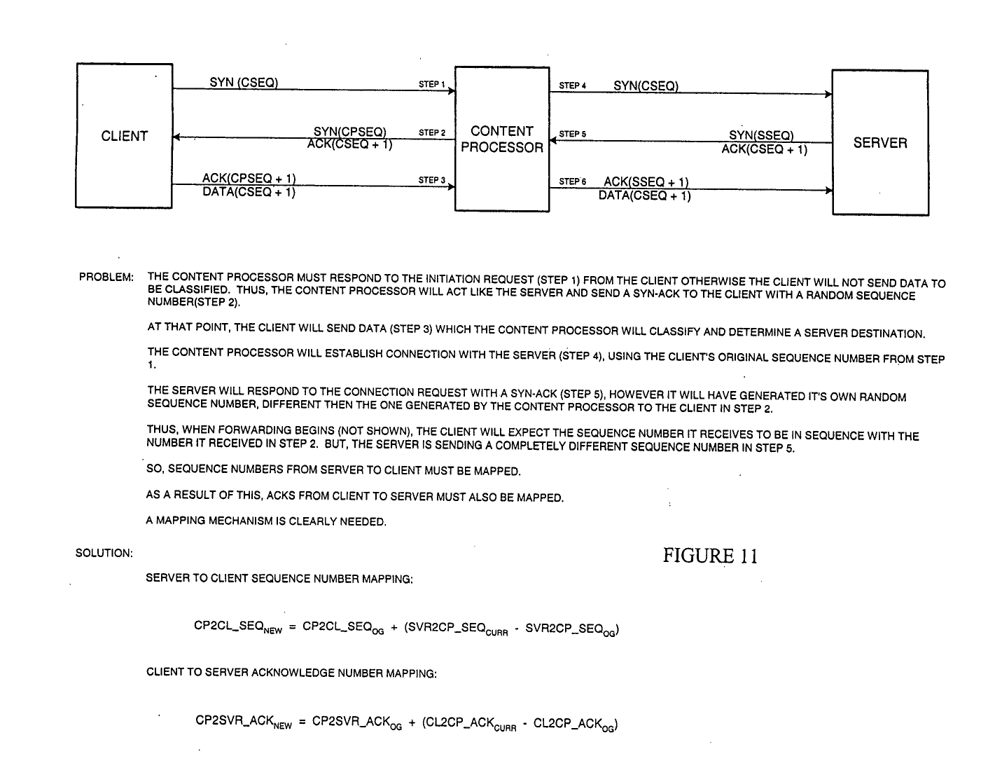

Another issue the TCP layer must handle is the sequence and acknowledge number mapping that must occur once a connection has been made and packets are forwarded. The problem and solution are described in FIG. 11. FIG. 11 shows a diagram of sequence and acknowledge number mapping.

FIG. 10 shows a hash generation unit. The Hash Generation Unit will accept the IP source and destination address, TCP source and destination port, and the source physical port from the Extractor Buffer. It will use this information to generate a hash. The hash result will be stored into a queue for the Table Fetch Unit to dequeue.

The Hash Generator will calculate 2 hashes in parallel. One will contain a different initial value or constant value for calculation. This second hash is used for verification purposes once the entry is retrieved.

The Hash unit may also be used by Software to assist in Hash calculation, thus a mechanism must be created to indicate to this block whether the result will be fed to the Table Fetch Unit or stored into the output queue for Software.

A programmable register allows software to initialize the hash constant used to generate the hash key. If no value is given a default hash value will be used. The Hash Constant Control Register is a 32-bit register divided into bits 31 to 24, 23 to 16, 15 to 8, and 7 to 0. In an implementation, this register may not be needed, due to hardware optimizations of the hash generator. The generator will execute faster with a restrictive hash generator design, then allowing a flexible programmable hash constant.

FIG. 10 shows a table fetch unit. The Table Fetch Unit will take a hash from the Hash Generation Unit and fetch that hash location from system memory. Once the table is read into the Content Processor, the Table Fetch Unit still must perform a number of hash comparisons to verify that the correct entry was fetched. Typically, this process will take at least 20 clock cycles.

A connection table cache is maintained to minimize the accesses to system memory. It will be as large as possible, because each packet will require this information to be fetched and a table fetch to main memory is an extremely costly function. Thus, it is extremely beneficial if this information were stored in the CP.

The hash and table fetch units will operate in a pipeline, thus, the latency required of each block will be slightly countered by the pipeline factor.

FIG. 10 shows a packet builder block. The Packet Builder will receive control inputs from the Packet Engine and place re-built packets in the output queue. The Packet Builder will be required to write the correct results into the output queue entry, such as the correct MAC physical port and packet byte count.

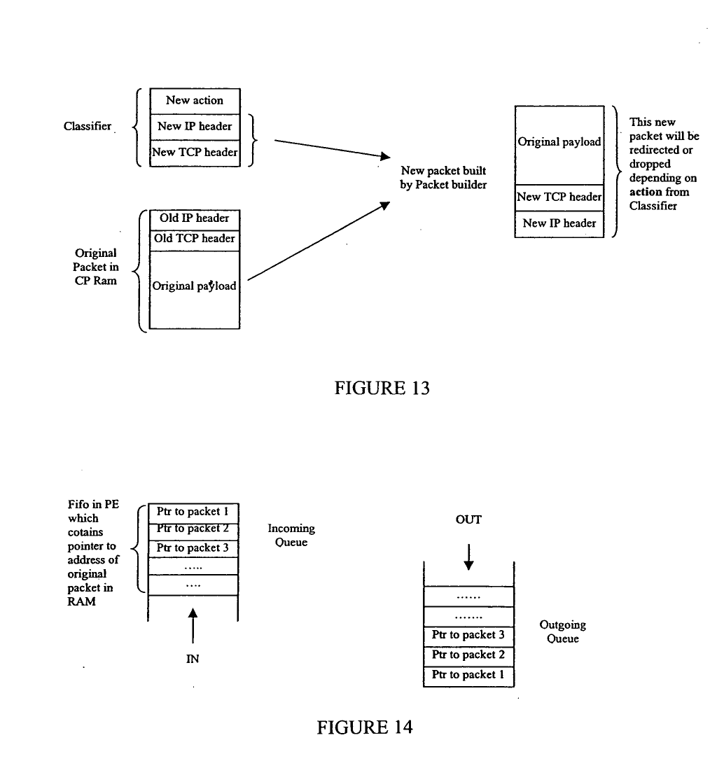

The packet builder is part the packet engine. FIG. 13 shows a top view of the packet building process. Its function is to build IP packet as it will be sent out through the lower network interface, the MAC interface. To build a packet, the packet builder needs to get information from the classifier, packet engine and the CP ram. From the classifier, this information are transferred through a 64-bit bus:

Action, which tells the packet builder what to do such as redirect, drop packet or just stay in idle. In case of redirection, the classifier needs to supply information about the IP and TCP header. In case of dropping the packet, the packet builder just simply mark the original packet as invalid in the packet engine's list.

From the packet engine, the packet builder gets the address where the original packet is stored in the CP ram, the address bus is 32 bit width. From the CP ram, it gets all information about the original packet through 64-bit bus.

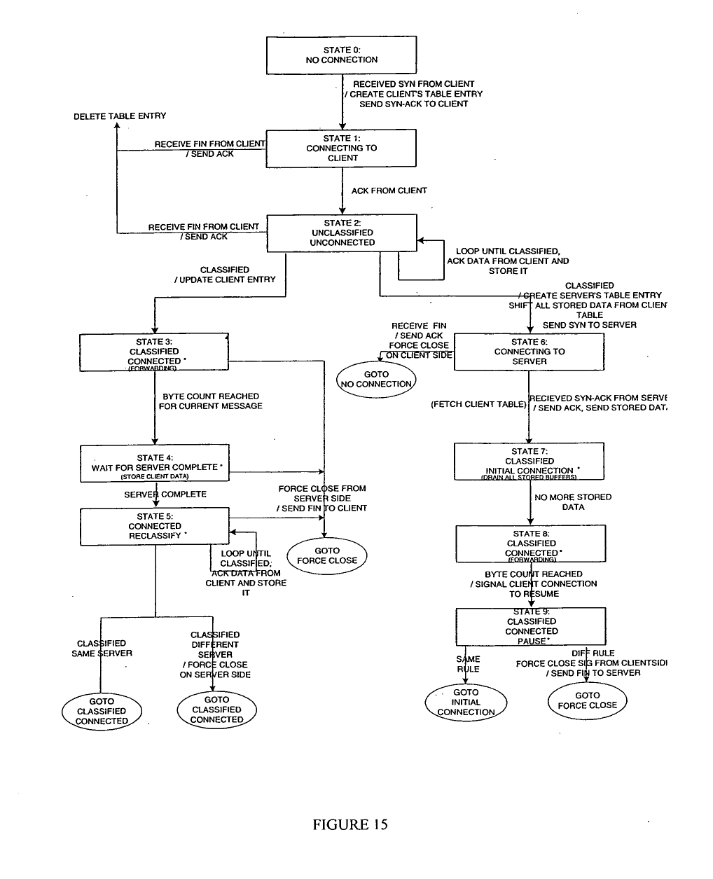

FIG. 14 shows a FIFO of pointers to addresses in the RAM tat is expected from the packet engine. With this information, the packet builder now can build a new packet by inserting the new data about the TCP/IP into the original packet, generating sequence number, and recalculating checksum. After rebuilding, the new packet will be stored back in the CP ram at the address of the original packet, and the packet builder also signals to the MAC interface to tell MAC that the packet was rebuilt and where it can get that packet.

The packets that this module will need to build are as follows. SYN is for Synchronize Packets to the Server for connection establishment. This will occur after Classification, and after a Server has been selected.

ACK is for Acknowledge Packets to the Client and Server. Client Acks are created immediately after the reception of a new connection SYN packet from the client. An ACK must immediately be sent back to the client so that the client will send application layer data which the Content Processor can Parse and Classify. Also ACKS for data packets may need to be generated to the Client. Server ACKS are created after Classification and reception of a SYN-ACK from the Server indicating that it is ready to receive data packets. At this point, the CP will generate an ACK packet with data that has been stored away for the current connection.

Forward Pkts are for after a connection has been established it is simply a matter of forwarding the packets from client to server and server to client. However, it still requires TCP/IP header modification and checksum calculation. Refer to FIG. 11.

ICMP Packets are used during IP error handling or control handling, such as PINGing and Host Unreachable Messages.

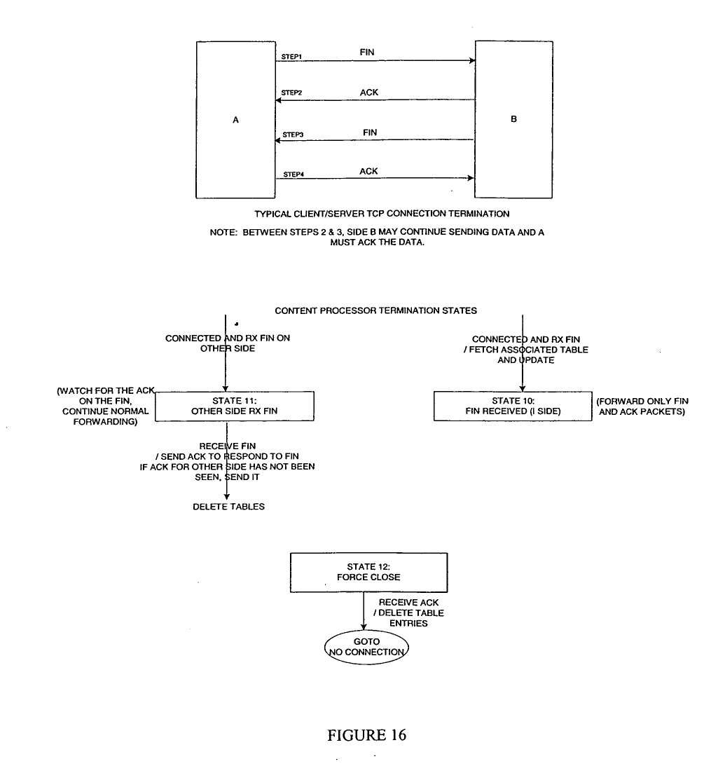

FIGS. 15 and 16 show a flow diagram of content processor packet connection flow. Following is an example packet flow through the Packet Flow.

1. Host CPU initializes Content Processor's Input Instruction Queue with incoming packets. Also initializes the MAC chip with the same list of Receive Buffers all located inside CP memory.

2. Packets are transferred from the MAC chip directly to the CP memory through the PCI bus.

3. As packets enter the Packet Engine, the interface will transfer them to the CP memory, at the same time packets will be fed through the Packet Pre-processor. The Packet Pre-processor will perform TCP/IP header extraction and checksum checking. This can take multiple PCI bus cycles.

4. After packet pre-processing has completed, the IP source and destination address, and TCP source and destination ports are passed to the Hash Generator.

5. The Hash Generator will take the information and calculate 2 hashes. One is used to index the memory, the other is used to verify the entries retrieved.

6. The hash keys are passed to the Table Fetch Unit, which will use the hash as an address to system memory. The address location is fetched from system memory and verified with the second hash.

7. After the table is fetched and verified, the TCP processor is notified of a completed segment that is ready for processing. The TCP Processor updates the connection table with the extracted header information. Determines it's a new request.

8. The Packet Builder is signaled by the TCP Processor to build a SYN-ACK packet. The Builder generates the SYN-ACK packet with information located in the connection table. The new packet is placed on the output queue for delivery out onto the network.

9. In parallel, the TCP processor also signals the Parser that a new segment is arriving. It passes all handle, TCP/IP header information to Parser first. Then segment data is followed, if any. In this case, only the TCP/IP info is passed to Parser.

10. Parser builds a descriptor with the available information, voiding all other fields that it does not receive, such as HTTP headers. This is passed to the Classifier.

11. Classifier attempts classification, fails and signals the Packet Engine that the packet has not been classified.

12. The Client responds to the SYN-ACK sent earlier with an ACK and data.

13. Pre-processing, hashing, table-fetching all must occur again. Step 3-7.

14. TCP processor checks the connection table, determines the state of the connection, and forwards the data segment along with handle, TCP/IP information.

15. Parser parses the data. Is able to build a more complete descriptor for the Classifier, including HTTP header information.

16. Descriptor Builder is passed to Classifier for classification. Classification is attempted and successful, a signal is sent to the Packet Engine with the result.

17. Packet Engine receives the Classifier signal and updates the connection table.

18. TCP Processor checks the connection state and determines that a connection with the server can be established. Sends a signal to Packet Builder to build SYN packet to the Server.

19. Packet Builder builds the SYN packet using information in the connection table and places it on the output queue.

20. Wait for Server response. SYN-ACK is received from Server. Steps 3-7 are performed again.

21. TCP Processor checks connection table to determine state. Sends a signal to Packet Builder to send out an ACK packet with the already received data from the Client.

22. Packet Builder builds the new packet with information from the connection table and places the packet on the output queue.

23. After receiving ACK from server, connection has been established and forwarding can proceed.

24. At this point, steps 3 to 7 are repeated. TCP Processor notices the connected state, and signals the Packet Builder to perform the forwarding modification to the packet. The new packet is placed on the output queue and forwarded.

This flow clearly shows that Parser and Classifier processing is minimal. The bulk of the processing occurs with the Packet Engine, namely with the hash generation and table look up. Steps 3 to 7 should be optimized.

This detailed description of the invention has been presented for the purpose of illustration and description. It is not intended to be exhaustive or to limit the invention to the precise form described. Many modifications and variations are possible in light of this detailed description. The embodiments were chosen and described in order to best explain the principles of the invention and its practical applications. Others skilled in the art will recognize that various modifications can be made in order to best utilize and practice the invention for a particular application. The scope of the invention is defined by the following claims.

What is claimed is:

1. A method of processing packets received over a network comprising:
receiving a data packet from a client into a content processor;
performing packet header extraction and checksum checking on the data packet;
updating a connection table with extracted header information generated from the packet header extraction;
checking a connection state between the content processor and a target server to determine that a connection with the target server can be established;
building a synchronize packet using information in the connection table;
sending the synchronize packet to the target server;
building a new data packet including the received data packet from the client and information from the connection table; and
forwarding the new data packet to the target server when the target server indicates the target server is ready to receive data,
wherein a plurality of new data packets are stored in the content processor until the target server is ready to receive data and a sufficient amount of data is received from the client, thereby freeing available server resources.

2. The method of claim 1 further comprising:
based on the extracted header information, determining whether the data packet is from a wireless client;
if the packet is from a wireless client, terminating any connection between the client and the target server until a sufficient amount of data is received from the wireless client.

3. The method of claim 2 further comprising:
switching the wireless client to a subsequent server that is faster than a non-wireless client.

4. The method of claim 1 further comprising changing a priority of the data packet in a queue of packets.

5. The method of claim 1 further comprising lowering a priority of the data packet.

6. The method of claim 1 further comprising increasing a priority of the data packet.

7. A network content processor device configured to process data packets, the device comprising:
a packet processor configured to receive data packets from a client, edit the data packets, and forward the data packets to a target server;
a policy-based classifier containing a policy database for classifying network traffic per flow; and
a protocol parser configured to receive information from the packet processor and to form a query to search in the policy database of the policy-based classifier,
wherein the data packets are stored in the packet processor until the target server is ready to receive the data packets and a sufficient amount of data is received from the client, thereby freeing available server resources.

8. The device of claim 7 wherein based on the policy database, the device is configured to determine whether the client is a wireless client,
wherein if the client is a wireless client, the device acts as a proxy to terminate any communication between the client and the server until a sufficient amount of data is received from the client, thereby minimizing communication between the wireless client and the server.

9. The device of claim 8 wherein the wireless client is switched to a subsequent server that is faster than a non-wireless client, the switching being based on the policy database.

10. The device of claim 8 wherein multiple protocols are supported.

11. The device of claim 10 wherein the multiple protocols comprise binary and/or text based protocols.

12. The device of claim 10 wherein the multiple protocols include TCP/IP and HTTP.
